(19) United States
(12) Patent Application Publication
(10) Pub. No.: US 2022/0256654 A1
(43) Pub. Date: Aug. 11, 2022

(54) ENGINEERED CNT SURFACE FOR IMPROVED THERMAL CONVERSION EFFICIENCY AND IMPROVED CNT-BASED SCENE PROJECTOR

(71) Applicants: Joseph D LaVeigne, Buellton, CA (US); Gregory P Matis, Santa Barbara, CA (US); Thomas E Danielson, Santa Barbara, CA (US)

(72) Inventors: Joseph D LaVeigne, Buellton, CA (US); Gregory P Matis, Santa Barbara, CA (US); Thomas E Danielson, Santa Barbara, CA (US)

(21) Appl. No.: 17/580,580

(22) Filed: Jan. 20, 2022

Related U.S. Application Data
(60) Provisional application No. 63/139,767, filed on Jan. 20, 2021.

(51) Int. Cl. H05B 3/00; C01B 32/158

(52) U.S. Cl. CPC H05B 3/0038; C01B 32/158; B82Y 20/00; C01B 2202/24; C01B 2202/08; H05B 2214/04

(57) ABSTRACT

In an infrared (IR) scene projector device or thermal emission array comprising a plurality of vertically aligned carbon nanotubes disposed proximate to a thermally conductive substrate, the plurality of carbon nanotubes (CNTs) may be (i) arranged as in FIGS. 2 and 4B as a sparsely populated forest, with large gaps between the CNTs; or (ii) arranged as in FIGS. 3 and 4C as patches (clusters) of CNTs separated by gaps; or (iii) arranged as a combination of clusters separated by gaps wherein each cluster comprises a sparsely populated forest of CNTs.

### CROSS-REFERENCE TO RELATED APPLICATION(S)

This application claims priority (filing date benefit) as:
a nonprovisional of 63/139,767 filed 20 Jan. 2021

### BACKGROUND

Carbon nanotubes provide a near-ideal absorber for a wide range of visible and infrared wavelengths. One possible use is as a thermal conversion media absorbing light of one wavelength or wavelengths and re-radiating as a thermal source. Their use in an infrared scene projector is disclosed in U.S. Pat. No. 8,552,381, which describes a vertically aligned CNT forest where the tubes are connected to a substrate on one end and extend closely packed and approximately vertically forming a secondary surface with the exposed tips, somewhat resembling shag carpet. Illumination of the exposed tips causes them to heat. With a near unity emissivity, the tips then act as thermal radiators. When the input illumination is removed, the tubes return to the temperature of the underlying substrate. Response time of the tubes is a function of their length, with shorter tubes reaching equilibrium faster than longer tubes, though the temperature above background of the shorter tube would be lower than that of longer tubes under the same illumination.

While much of the energy absorbed by the tubes is conducted down the axis of the tube, some lateral losses can occur due to contact with neighboring tubes or by transmission through a medium, such as air, if the nanotube mat is not held in a vacuum. These losses can be quite significant if the length scale of the illuminated area on the surface is comparable to or smaller than the length scale of the nanotubes.

### SUMMARY

It is an object of the invention generally, to provide an improved CNT array having, for example, improved thermal conversion efficiency.

It is an object of the invention, generally, to provide improved apparatus utilizing the improved CNT array such as, but not limited to (i) an infrared (IR) scene projector device, (ii) a thermal emission array and (iii) a CNT-based scene projector.

The invention disclosed herein deals generally with improving the conversion efficiency of a mat (array, forest) comprising a plurality of CNTs, wherein visible light may be directed at the mat, and the energy of the visible light is “converted” to heat (infrared radiation), such as in a scene projector.

Generally, by way of example, the mat of CNTs may be illuminated with “out-of-band” light (such as a visible image) in the wavelength range of 800 nm down to 400 nm, or below, said illuminating light (or image) being converted by the nanotubes (CNTs) to “in band” infrared (IR) radiation such as in the wavelength range of 1-14 μm). In other words, the general purpose of the nanotubes and the mat (array) is to convert a visible (light, non-thermal) image to a heat (thermal) image.

The array of CNTs may comprise a plurality of CNTs extending “up” from a substrate upon which they may be grown (from “seeds”). In other words, the surface of the substrate may be populated by CNTs (nanotubes). Means for cooling the substrate may be provided on the opposite (unpopulated) side of the substrate.

A given CNT may have a proximal end on the substrate, and a distal end “above” the surface of the substrate. The purpose of the substrate may be to cool down the CNTs after they have been illuminated and their distal ends heated by visible light, which may be an image. The substrate may be a planar surface. The CNTs may all have approximately the same length, thus their distal ends may all be substantially coplanar with one another.

A modification of the CNT mat is disclosed to enhance the conversion efficiency (converting light into heat). A problem with a closely-packed array of CNTs (or nanotubes) is that they may lose heat to their neighboring (adjacent) CNTs. This lateral transmission, from CNT-to-CNT may be controlled by limiting the possibility of a nanotube contacting neighboring nanotubes by either (i) controlling the sparsity of the growth of nanotubes allowing a continuous, but less dense forest, or by (ii) providing (engineering) gaps between areas of closely packed nanotubes, effectively pixelating the surface. By limiting the lateral losses, higher temperatures can be achieved with smaller illuminating spots. This may improve efficiency as well as reducing the variation of the output on the size of the input spot.

More sparse arrays can be grown by controlling the seed layer. Gaps can be created by patterning the seed layer prior to growth or by removing tubes after growth. (A seed layer is typically a metal catalyst, such as iron or nickel, that initiates growth of the nanotubes.)

As used herein, a plurality of CNTs grown on a surface may be referred to as a “mat”, a “forest”, and “array” or the like.

According to the invention, generally, various “arrays” of CNTs are disclosed comprising a plurality of carbon nanotubes (CNTs) which are aligned generally parallel with one another, extending vertically from an underlying surface (of a substrate), forming a vertically aligned carbon nanotube (VACN) array. Each nanotube is elongated, having a proximal end which may originate at the underlying surface, a distal end which is at a given distance from the surface, a longitudinal axis between the proximal and distal ends, and the longitudinal axis extends substantially perpendicular to the surface of the substrate. Such an array of CNTs is well adapted to absorb light and convert it into thermal energy, such as infrared (IR) radiation.

In some embodiments, several CNTs are individually spaced far apart from one another, forming a sparsely-populated “forest”, or “array” of CNTs. In some embodiments, several CNTs are clustered in a single patch of CNTs, and several clusters of CNTs are individually spaced apart from one another. In some embodiments, each cluster may comprise a sparsely-populated “forest”, or “array” of CNTs.

The carbon nanotubes are capable of converting light directed thereon into infrared (IR) radiation. The IR radiation being emitted by the thermal emission array may result from (be based on) selective provision of the light to the VACN, such as an image.

An improved CNT-based scene projector may comprise: a plurality of carbon nanotubes (CNTs), generally aligned with one another, wherein the plurality of CNTs are: arranged per FIGS. 2 and 4B as a sparsely populated forest, with large gaps between the CNTs; or arranged per FIGS. 3 and 4C as patches (clusters) of CNTs separated by gaps; or arranged as a combination of clusters separated by gaps and each cluster comprises a sparsely populated forest of CNTs.

Other objects, features and advantages of the invention(s) disclosed herein may become apparent in light of the following illustrations and descriptions thereof.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be stylized, simplified or exaggerated, others may be omitted, for illustrative clarity.

Although the invention is generally described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

Some elements may be referred to with letters (such as “IR”, “CNT”, etc.) rather than or in addition to numerals. Some similar (including substantially identical) elements in various embodiments may be similarly numbered, with a given numeral such as “310”, followed by different letters such as “A”, “B”, “C”, etc. (resulting in “310A”, “310B”, “310C”), and may collectively (all of them at once) referred to simply by the numeral (“310”).

The following figures may be referred to and/or described in the text.

FIG. 1 is a diagram (cross-sectional view) of a typical CNT forest of the prior art, describing various loss mechanisms, such as convection, lateral conduction from radial CNT contact, and IR radiative losses.

FIG. 2 is a diagram (cross-sectional view) of a more sparse forest grown by increasing the spacing between the “islands” of the seed metal, according to an exemplary embodiment of the invention. In other words, the CNTs are farther apart from one another as compared with the prior art (FIG. 1). The managed growth of the “sparse forest” may be achieved using nano-dot seed growth.

FIG. 3 is a diagram (cross-sectional view) of a “pixelated” forest with gaps between clumps of nanotubes, according to an exemplary embodiment of the invention. A given clump may comprise a number (“n”) of nanotubes (CNTs), and there may be several (“m”) of such clumps. The clumps may be distributed in a regular pattern across the surface of the substrate. An exemplary patch (or clump) of CNTs may comprise a number (“n”) of nanotubes spaced a relatively small distance such as 10 μm apart from one another. An exemplary patch or clump of CNTs may be spaced a greater distance, such as 1 μm from neighboring clumps. In other words, in a given clump of CNTs, the individual CNTs may be spaced a first distance from one another, and clumps of CNTs may be spaced a second distance from one another, wherein the second distance is greater than the first distance, such as by a factor of 5×, or more.

FIG. 4A (corresponding with FIG. 1B of U.S. Pat. No. 8,552,381) is a diagram (plan view) showing the top (distal) ends of a plurality (forest, array) of CNTs, according to the prior art. A substrate from which the CNTs extend is omitted, for illustrative clarity. Compare FIG. 1 (prior art).

FIG. 4B is a diagram (plan view) showing the top (distal) ends of a plurality of CNTs, according to an exemplary embodiment of the invention, and corresponds roughly with FIG. 2 (sparsely populated forest of CNTs).

FIG. 4C is a diagram (plan view) showing the top (distal) ends of a plurality of CNTs, according to an exemplary embodiment of the invention, and corresponds roughly with FIG. 3 (patterned substrate with patches (clusters) of CNTs separated from other clusters of CNTs. The clusters may be arranged in an approximately regular, closely packed pattern, such as a hexagonal or honeycomb structure.

Legends and text appearing in the drawings are incorporated by reference herein.

### DETAILED DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein.

Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

Reference may be made to disclosures of prior patents, publications and applications. Some text and drawings from those sources may be presented herein, but may be modified, edited or commented to blend more smoothly with the disclosure of the present application.

By way of general background, carbon nanotubes (CNTs) are tubes made of carbon with diameters typically measured in nanometers. Carbon nanotubes often refer to single-wall carbon nanotubes (SWCNTs) with diameters in the range of a nanometer. Single-wall carbon nanotubes are one of the allotropes of carbon, intermediate between fullerene cages and flat graphene. Carbon nanotubes also often refer to multi-wall carbon nanotubes (MWCNTs) consisting of nested single-wall carbon nanotubes weakly bound together by van der Waals interactions in a tree ring-like structure. Carbon nanotubes can also refer to tubes with an undetermined carbon-wall structure and diameters less than 100 nanometers. The length of a carbon nanotube produced by common production methods is typically much larger than its diameter. Either SWCNTs or MWCNTs may be used with the present invention.

U.S. Pat. No. 8,552,381 (Fainchtein et al.; 2013-10-08; '381), incorporated by reference herein, discloses Agile IR scene projector. An infrared (IR) scene projector device includes a light emitter and a thermal emitter. The light emitter is configured to selectably provide visible light. The thermal emitter includes a vertically aligned carbon nanotube (VACN) array. The VACN array includes a plurality of carbon nanotubes disposed proximate to a thermally conductive substrate, such that a longitudinal axis of the carbon nanotubes extends substantially perpendicular to a surface of the substrate. The thermal emitter absorbs the visible light from the light emitter and converts the visible light from the light emitter into IR radiation.

The independent claims of the '381 patent are directed to:
1. An infrared (IR) scene projector device comprising:
   a light emitter configured to selectably provide visible light; and

a thermal emitter comprising a vertically aligned carbon nanotube (VACN) array, the VACN array comprising a plurality of carbon nanotubes disposed proximate to a thermally conductive substrate such that a longitudinal axis of the carbon nanotubes extends substantially perpendicular to a surface of the substrate, the thermal emitter absorbing the visible light from the light emitter and converting the visible light from the light emitter into IR radiation.
16. A thermal emission array comprising:
   a thermally conductive substrate; and
   a plurality of vertically aligned carbon nanotubes (VACN), the carbon nanotubes being disposed proximate to the thermally conductive substrate such that a longitudinal axis of the carbon nanotubes extends substantially perpendicular to a surface of the substrate, wherein the carbon nanotubes convert visible light directed thereon into IR radiation, the IR radiation being emitted by thermal emission array based on selective provision of the visible light to the VACN.

It is an overall object of the invention to provide a plurality (mat, forest, array) of CNTs having improved conversion efficiency. Such a mat of CNTs may be used, for example, to improve the performance a CNT-based scene projector.

Generally, an infrared (IR) scene projector may comprise an illumination source (visible light), a mat (of CNTs) on a substrate, and a cooling system. An exemplary scene projector may be disclosed in U.S. Pat. No. 8,552,381.

“Conversion” as used herein, may refer to the generation of heat (infrared radiation) in response to incident visible light. The incident light may be provided in a number of ways, such as with one or more lasers. Generally, a visible image may be projected by projector onto (or directed at) the mat of CNTs. The light image directed at and impacting upon the distal ends (tips) of the CNTs may be converted to heat by the CNTs (warming up) and conducted by the CNTs to a proximal end of the CNTs which extend from (are mounted upon) an underlying plate (substrate). A thermal image may thus be created by the incident light on the distal ends (tips) of the CNTs. Upon removal of the incident light, the thermal image thus created on the mat (forest, array) of CNTs may be re-radiated by the tips of the CNTs which were heated by the incident light. The underlying plate (substrate) allows the CNTs to cool down to ambient temperature after the light is removed. Means for cooling the substrate (not shown) may be provided, such as on the opposite (not populated by CNTS) side of the substrate.

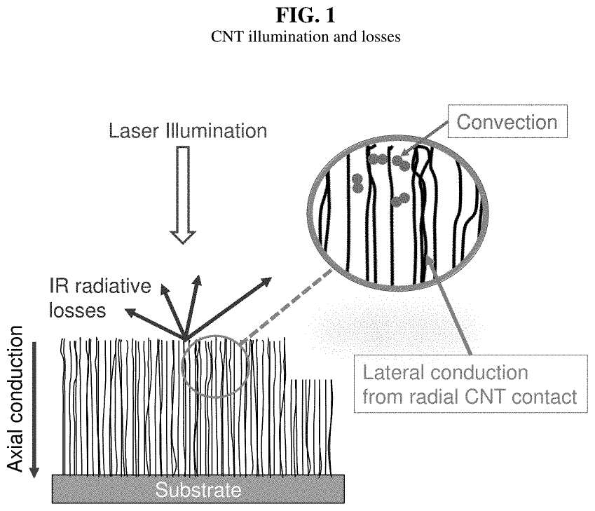

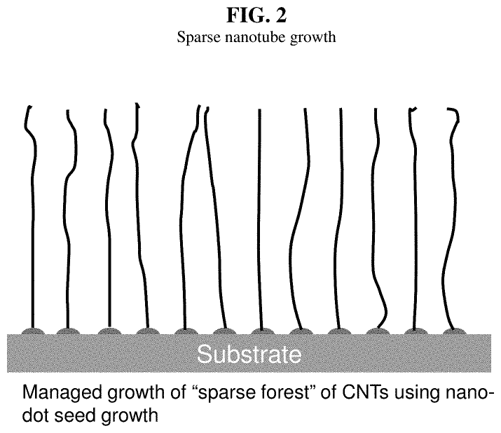

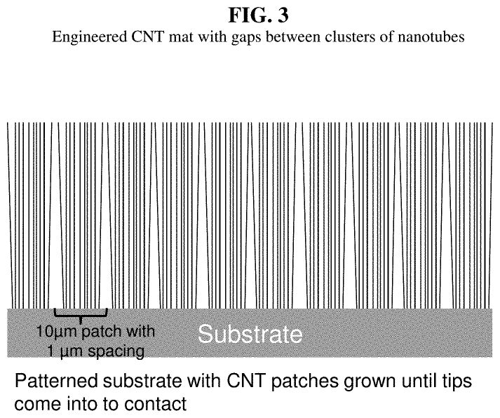

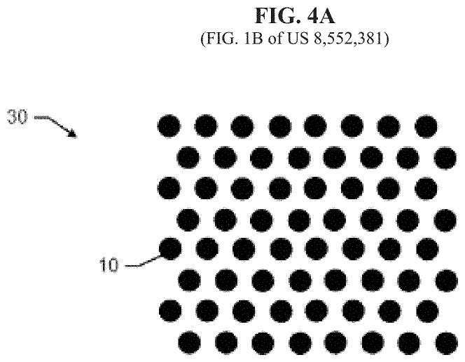

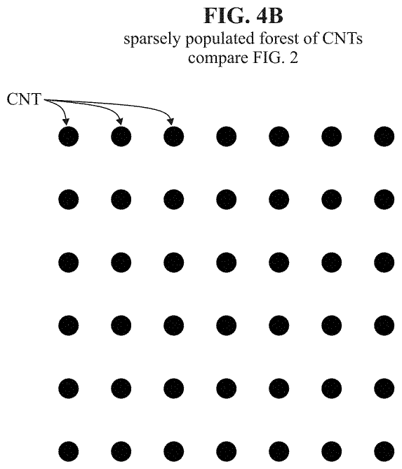

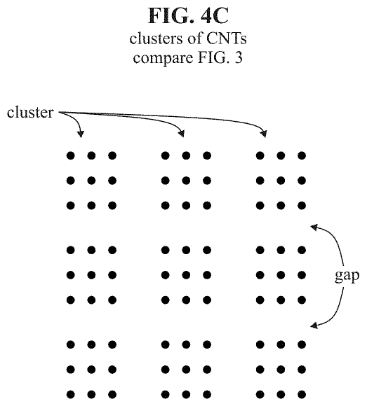

Generally, rather than having an array of more or less uniformly (and densely) distributed CNTs (see FIGS. 1, 4A), the array (or mat, or forest) of CNTs may be arranged (engineered) to be less uniform (and less dense), such as by arranging the CNTs to be:
(alt 1) spaced farther apart than “normal” (FIGS. 2, 4B)
(alt 2) distributed in clumps of CNTs, separated by gaps (FIGS. 3, 4C); or
(hybrid solution) a combination of spacing the CNTs farther apart (alt 1) and distributing them in clumps (alt 2)—in other words, combining the concepts (features of embodiments) disclosed in FIGS. 2/4B and 3/4C).

A typical CNT may have a diameter of 10-100 nm, such as 30 nm, or less than 30 nm, and may have a length (height) of greater than or equal to approximately 10 μm, including 100's of μm. Refer to U.S. Pat. No. 5,882,381 for a description of some exemplary CNTs and their use in a IR scene projector.

Such CNTs may have a very large aspect ratio (height:diameter), and since they may not grow “perfectly” straight, when arranged close to one another, they may touch, causing lateral heat loss and “blurring” of the desired image. FIG. 2 illustrates of non-straight CNTs.

A scene projector may provide a “pixellated” IR image comprising a number of “spots”. A typical spot may have a cross-dimension (a la diameter) of 20-30 μm, or approximately 1000 times the diameter of a single CNT. Hence, there may be many tens of thousands, or millions of CNTs in a given spot of an image.

Data shows that small spots (on the order of 20-30 microns—about the size of a pixel in a projected image) may have very low output, only getting a few degrees above the projector substrate (background, conductive) temperature, while larger spots (˜300 microns) may be much hotter, increasing to over 1000° C. with the same irradiance (power/unit area).

### alt 1. FIGS. 2, 4B (CNTs Spaced Farther Apart)

space individual CNTs farther apart, not closely packed
space between individual CNTs is many times greater than their diameter, such as up to 100 nm, so that they touch each other less.
   alt 2. FIGS. 3, 4C (Clumps of CNTs with Gaps Therebetween)
one “clump” (or group, or subset of the entire mat or forest) of CNTs may comprise hundreds or thousands of CNTs on a side, totaling tens of thousands or millions of CNTs per pixel (clump).
A typical pixel may have a cross-dimension of ˜1 μm. A typical spot size may be 20-30 μm, thus comprising several pixels (clumps).
the gaps between adjacent clumps of CNTs may be a small fraction, such as 1-20% of the pixel size (˜1 μm)

Generally, in either alternative (alt 1, alt 2), there may be fewer (as compared with a prior art mat, such as in FIG. 1) total CNTs (or “tubes”), resulting in the mat being easier to heat up (a benefit), because of less absorption (fewer CNTs). However, since lateral conduction losses from radial CNT contact is minimized (see FIG. 1), the underlying IR projector surface (“substrate”, in the drawings) may be more responsive. In other words, a small decrease in absorption may yield a big return in how the underlying (projector, for example) surface heats up.

The overall “issue” being addressed by the present invention may be characterized as how to efficiently illuminate a small spot (20 μm) onto a 10 μm pixel/patch size. An overall array (and corresponding image) may comprise 1000×1000 spots, and may measure 20-25 mm (on a side). By reducing CNTs touching each other, lateral (conductive and convective) losses between neighboring CNTs may be minimized (lessened). This is desirable, since such losses tends to spread out (blur) the image, reducing the efficiency of the forest for small spots. By minimizing such losses, image resolution and precision may be maximized (increased). There may thus be provided an improved infrared scene projector using vertically aligned carbon nanotubes (VACN).

FIG. 1 is a diagram (cross-sectional view) of a CNT forest, illustrating various loss mechanisms. This is representative of the prior art (e.g., U.S. Pat. No. 8,552,381).

The figure illustrates a number of CNTs which are closely packed together. The figure illustrates CNT illumination and losses. Illumination may be by laser light (such as visible light) directed at the tips (distal ends) of the CNTs, which become heated and conduct (axial conduction) the resulting heat to their proximal ends which are mounted to a substrate. The figure illustrates that heat losses (exchange of heat between adjacent CNTs) may occur due to (i) convection and/or (ii) lateral conduction from radial (transverse to their longitudinal axis) contact between the CNTs.

As shown in the figure, there may also be IR, radiative losses. The present invention is mainly directed at minimizing convection and/or lateral conduction losses.

FIG. 2 is a diagram (cross-sectional view) of a more sparsely populated (by CNTs) forest (or mat). The mat may be grown by increasing the spacing (or gaps) between adjacent “islands” of the seed metal, resulting in large gaps between adjacent CNTs. Refer to the discussion of “alt 1”. See also FIG. 4B. This may be referred to as “managed growth” of a “sparse forest”, which may be accomplished by nanodot seed growth, resulting in an “engineered” CNT mat (or surface) having improved thermal conversion efficiency.

This figure illustrates that due to the large height:diameter aspect ratio of CNTs, they could easily touch each other, resulting in lateral conduction losses (such as was described with respect to FIG. 1). Nevertheless, some benefits, as may be described herein, may accrue to such a sparsely-populated forest of CNTs. FIG. 4B is another view of such a sparsely-populated forest of CNTs, as contemplated in the above-referenced “alt 1”.

FIG. 3 illustrates an “engineered” CNT mat with several individual clusters having many CNTs each, and gaps between adjacent clusters of nanotubes. This figure illustrates a “pixelated” forest of CNTs with gaps between “clumps” (or patches, or clusters) of nanotubes. Refer to the discussion of “alt 2”.

This figure shows that the CNTs may be arranged in several “patches” (or “clumps”) separated by gaps. An individual patch may measure 10 μm across. Neighboring (adjacent) patches may be spaced apart by 1 μm. See also FIG. 4C. This may be referred to as engineered CNT mat with gaps between clusters of nanotubes.

FIG. 4A (corresponding with FIG. 1B of U.S. Pat. No. 8,552,381) is a diagram showing a top (end) end view of plurality (forest, array) of CNTs, according to the prior art.

As described in the '381 patent, FIG. 1B shows a top view of a plurality of CNTs 10 viewed from their respective distal ends and looking down their longitudinal axes toward the substrate. The VACN array 30 created by the CNTs 10 may include a plurality of vertically aligned cylinders of very high aspect ratio that can be irradiated at one end and convert light to heat that quickly moves toward the substrate.

FIG. 4B is a diagram showing an end view of a plurality of CNTs, according to an embodiment of the invention, and corresponds roughly with FIG. 2 (sparsely populated forest of CNTs).

Several (seven shown) exemplary rows (from left-to-right) of CNTs are shown, which may be spaced widely apart from one another, as described above (FIG. 2). In this illustration, the distal ends (tips) of the CNTs are shown as dots (•). The wide (large) spacing between adjacent CNTs ensures that, in the resulting sparsely populated forest, there is minimal contact and thermal loss with neighboring CRTs

The CNTs in a given row may be evenly spaced from one another (as shown). Alternatively, the CNTs in a given row may be unevenly spaced from one another.

As illustrated, the rows of CNTs may be aligned with one another, with the CNTs of one row being directly above/below the CNTs of an adjacent (neighboring) row. Alternatively, the rows of CNTs may be staggered, so that the CNTs of one row are not directly above/below the CNTs of the neighboring rows, such as in a pattern resembling FIG. 4A.

In a similar manner, the columns of CNTs shown in FIG. 4B may be aligned with one another (as shown). Alternatively, the rows of CNTs may be staggered, so that the CNTs of one column are not directly to the left or right (as viewed) of the CNTs of the neighboring columns, such as in a pattern resembling FIG. 4A.

The number of CNTs in the mat (forest, array) is merely exemplary, for illustrative clarity. This illustration may be considered to be a look at only a section of the overall array of CNTs within the mat.

The feature of interest being illustrated in FIG. 4B is that the CNTs are spaced more widely from one another, in contrast with the prior art, to reduce convection and lateral conduction losses (see FIG. 1).

FIG. 4C is a diagram showing an end view of a plurality of CNTs, according to an embodiment of the invention, and corresponds roughly with FIG. 3 (patterned substrate with patches (clusters) of CNTs separated from other clusters of CNTs. In this illustration, the clusters of CNTs are shown, each cluster having nine (9) representative dots (CNTs). Rows and columns of clusters are shown evenly spaced from one another, with gaps therebetween. The clusters are shown as being aligned with one another (the clusters of one row are directly above/below the clusters of an adjacent (neighboring) row, and the clusters of one column are directly to the left or right (as viewed) from the clusters of a neighboring column. Alternatively, the clusters could be staggered, in the manner shown (for individual CNTs) in FIG. 4A, so that the CNTs of one row (or column) are not directly above/below (or to the left or right of) the CNTs of the neighboring rows (or columns).

The clusters are illustrated as being evenly spaced from one another. Alternatively, the clusters may not be evenly spaced from one another.

The clusters may have different numbers of CNTs in them, then one another. The number of clusters and number of CNTs within a cluster are merely exemplary, for illustrative clarity. This illustration may be considered to be a look at only a section of the overall array of CNTs in the mat of CNTs on the substrate.

The clusters or CNTs shown in FIGS. 3 and 4C may each comprise (i.e., each cluster may comprise) a plurality of sparsely populated CNTs such as shown in FIGS. 2 and 4B.

The arrangements of CNTs disclosed herein may be applied to (utilized in) the following thermal apparatuses:
an infrared (IR) scene projector device
a thermal emission array
an improved CNT-based scene projector
an engineered CNT surface for improved thermal conversion efficiency

While the invention(s) may have been described with respect to a limited number of embodiments, these should not be construed as limitations on the scope of the invention(s), but rather as examples of some of the embodiments of the invention(s). Those skilled in the art may envision other possible variations, modifications, and implementations that are also within the scope of the invention(s), and claims, based on the disclosure(s) set forth herein.

What is claimed is:

1. An engineered CNT surface for improved thermal conversion efficiency comprising:
a plurality of carbon nanotubes (CNTs), aligned generally parallel with one another, each nanotube having a proximal and a distal end, wherein the plurality of CNTs are arranged as one or more of the following:
(FIGS. 2 and 4B) as a sparsely populated forest, with large gaps between adjacent CNTs; or
(FIGS. 3 and 4C) as several clusters of CNTs, wherein one cluster of CNTs is separated by a gap from neighboring clusters of CNTs;
as a combination of clusters separated by gaps, and each cluster comprises a sparsely populated forest of CNTs.

2. The engineered CNT surface of claim 1, wherein:
the CNTs (FIG. 4B) or clusters of CNTs (FIG. 4C) are arranged in rows and columns.

3. The engineered CNT surface of claim 2, wherein:
the rows and columns are evenly-spaced and aligned with one another.

4. The engineered CNT surface of claim 2, wherein:
the rows and columns are staggered.

5. The engineered CNT surface of claim 1, wherein:
the clusters of CNTs (FIG. 4C) are arranged in an approximately regular, closely packed pattern, such as a hexagonal or honeycomb structure.

6. An infrared (IR) scene projector comprising:
a light projector configured to selectably provide light; and
a thermal emitter comprising a vertically aligned carbon nanotube (VACN) array;
wherein the VACN array comprises a plurality of carbon nanotubes (CNTs) disposed proximate to a thermally conductive substrate such that a longitudinal axis of the carbon nanotubes extends substantially perpendicular to a surface of the substrate, the thermal emitter absorbing the light from the light projector and converting the light from the light projector into IR radiation;
wherein:
the VACN array comprises a plurality of carbon nanotubes (CNTs) arranged (FIGS. 2 and 4B) as a sparsely populated forest, with gaps between the CNTs such that there is minimal contact and thermal loss with neighboring CRTs; or
the VACN array comprises a plurality of carbon nanotubes (CNTs) arranged (FIGS. 3 and 4C) as patches (clusters) of CNTs separated by gaps; or
a combination of clusters separated by gaps and each cluster comprises a sparsely populated forest of CNTs.

7. The infrared (IR) scene projector of claim 6, wherein:
the light is visible light.

8. A thermal emission array comprising:
a thermally conductive substrate; and
a plurality of vertically aligned carbon nanotubes (VACN), the carbon nanotubes being disposed proximate to the thermally conductive substrate such that a longitudinal axis of the carbon nanotubes extends substantially perpendicular to a surface of the substrate, wherein the carbon nanotubes convert light directed thereon into IR radiation, the IR radiation being emitted by the thermal emission array based on selective provision of the light to the VACN;
wherein:
the VACN array comprises a plurality of carbon nanotubes (CNTs) arranged (FIGS. 2 and 4B) as a sparsely populated forest, with large gaps between the CNTs; or
the VACN array comprises a plurality of carbon nanotubes (CNTs) arranged per FIGS. 3 and 4C as patches (clusters) of CNTs separated by gaps; or
a combination of clusters separated by gaps and each cluster comprises a sparsely populated forest of CNTs.
